(19) United States
(12) Patent Application Publication
(10) Pub. No.: US 2007/0097029 A1
(43) Pub. Date: May 3, 2007

(54) Plasma display apparatus

(76) Inventor: Sang Jin Yoon, Chilgok-gun (KR)

Correspondence Address: KED & ASSOCIATES, LLP, P.O. Box 221200, Chantilly, VA, 20153-1200, US

(21) Appl. No.: 11/590,920

(22) Filed: Nov. 1, 2006

(30) Foreign Application Priority Data
Nov. 2, 2005 (KR) 10-2005-0104414

(51) Int. Cl. G09G 3/28

(52) U.S. Cl. 345/60

(57) ABSTRACT

The present invention relates to a plasma display apparatus. The plasma display apparatus according to a first aspect of the present invention includes a first electrode formed in a panel, and a first electrode driver configured to apply a driving waveform to the first electrode, wherein the first electrode driver applies different driving waveforms when motion images are output and when still images are output. In the plasma display apparatus constructed as described above according to an embodiment of the present invention, images are divided into still images and motion images. In the motion images, as a motion change increases, a driving waveform is varied by decreasing the number of set-up signals or sustain pulses, or by lowering a set-up voltage. Accordingly, the distortion of an image occurring as waveforms are varied can be minimized. Furthermore, there are advantages in that the margin of a driving signal can be enhanced, heat generated from a panel can be reduced, and damage to the panel can be prevented. In particular, there is an advantage in that a contrast characteristic of an image can be improved since a gray level difference can differ according to motion.

This Nonprovisional application claims priority under 35 U.S.C. § 119(a) on Patent Application No. 10-2005-0104414 filed in Korea on Nov. 2, 2005, the entire contents of which are hereby incorporated by reference.

### BACKGROUND

1. Field of the Invention

The present invention relates, in general, to a plasma display apparatus and, more particularly, to a plasma display apparatus, in which it can improve driving margin and an optical characteristic at the time of outputting motion images by improving driving waveforms.

2. Discussion of Related Art

A Plasma Display Panel (hereinafter, referred to as a “PDP”) is an apparatus configured to generate discharge by applying voltage to electrodes disposed in discharge spaces and to display an image including characters and/or graphics by exciting phosphors with plasma generated during the discharge of gas. The PDP is advantageous in that it can be made large, light and thin, can provide a wide viewing angle in all directions, and can implement full colors and high luminance.

In this case, a driving waveform of the plasma display apparatus is generally decided using still image as a reference. Accordingly, when designing a driving waveform, the driving waveform is decided using still images as a reference in the related art, so that the plasma display apparatus is driven using the same waveform even in the case of motion images. Accordingly, problems arise because a heat generation phenomenon is generated in the panel when reproducing the motion images, an optical characteristic such as contrast is poor, and power consumption is a lot. In general, driving margin of motion images is wider than that of still images. That is, in the case of the motion images, minute extinguishments of a cell or a reduction in luminance is rarely seen by the eyes of human. Accordingly, in the prior art, there is a problem in which the driving margin in motion images is not used efficiently.

### SUMMARY OF THE INVENTION

The present invention has been developed in an effort to provide a plasma display apparatus having the advantages of increasing driving margin, decreasing the generation of heat of a driving circuit, and improving an optical characteristic by varying driving waveforms according to an image change degree in the case of motion images with images being divided into still images and motion images.

A plasma display apparatus according to a first aspect of the present invention includes a first electrode formed in a panel, and a first electrode driver configured to apply a driving waveform to the first electrode. The first electrode driver applies different driving waveforms when motion images are output and when still images are output.

The image change degree may be decided by comparing a gray level difference of corresponding cells of a previous frame and a current frame.

The first electrode driver varies the number of set-up signals according to an image change degree.

The first electrode driver varies the amount of a set-up signal according to the image change degree.

The first electrode driver varies the number of sustain pulses applied in a sustain period according to an image change degree.

A plasma display apparatus according to a second aspect of the present invention includes a first electrode formed in a panel, and a first electrode driver configured to apply a driving waveform to the first electrode, wherein the first electrode driver sets a driving waveform applied to a first frame and a driving waveform applied to a second frame to differ from each other when a gray level difference of cells of the first frame and the second frame is greater than a first reference value.

The first frame and the second frame are two consecutive frames.

Furthermore, the first reference value is a constant value between 15 to 20% of a total number of gray levels.

### BRIEF DESCRIPTION OF THE DRAWINGS

FIG. 1 is a perspective view illustrating the construction of a PDP according to an embodiment of the present invention.

FIG. 2 is a view illustrating an embodiment of electrode arrangements of the PDP.

FIG. 3 is a timing diagram illustrating a method of driving a plasma display apparatus with one frame of an image being time-divided into a plurality of subfields.

FIG. 4 is a timing diagram illustrating an embodiment of driving signals for driving a PDP in still images.

FIG. 5 is a block diagram showing the construction of a plasma display apparatus according to an embodiment of the present invention.

FIG. 6 is a view illustrating a method of determining the degree of a motion change of the plasma display apparatus according to an embodiment of the present invention.

### DETAILED DESCRIPTION OF THE INVENTION

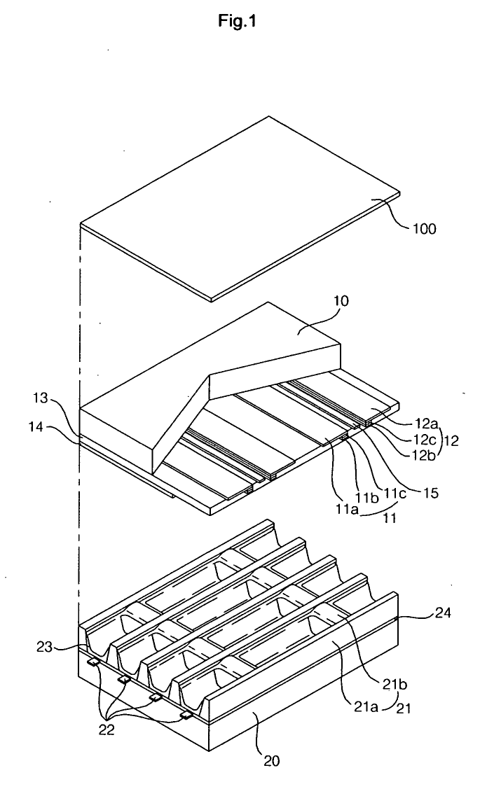

The present invention will now be described in detail in connection with specific embodiments with reference to FIGS. 1 to 6. FIG. 1 is a perspective view illustrating the construction of a PDP according to an embodiment of the present invention.

Referring to FIG. 1, the PDP includes a scan electrode 11 and a sustain electrode 12 (i.e., a sustain electrode pair) both of which are formed on a front substrate 10 , and address electrodes 22 formed on a rear substrate 20.

The sustain electrode pair 11 and 12 includes transparent electrodes 11a and 12a, and bus electrodes 11b and 12b. The transparent electrodes 11a and 12a are generally formed of Indium-Tin-Oxide (ITO). The bus electrodes 11b and 12b may be formed using metal, such as silver (Ag) or chrome (Cr), a stack of Cr/copper (Cu)/Cr, or a stack of Cr/aluminum (Al)/Cr. The bus electrodes 11b and 12b are formed on the transparent electrodes 11a and 12a and serve to reduce a voltage drop caused by the transparent electrodes 11a and 12a having a high resistance.

Meanwhile, the sustain electrode pair 11 and 12 according to an embodiment of the present invention may have a structure in which the transparent electrodes 11a and 12a and the bus electrodes 11b and 12b are laminated, or include only the bus electrodes 11b and 12b without the transparent electrodes 11a and 12a. Such a structure is advantageous in that it can save the manufacturing cost of the panel because it does not require the transparent electrodes 11a and 12a. The bus electrodes 11band 12b used in the structure may also be formed using a variety of materials, such as a photosensitive material, other than the above-mentioned materials.

Black matrices (BM) 15 are arranged between the transparent electrodes 11a and 12a and the bus electrodes 11b and 12b of the scan electrode 11 and the sustain electrode 12. The black matrices 15 has a light-shielding function of reducing the reflection of external light generated outside the front substrate 10 by absorbing the external light and a function of improving the purity and contrast of the front substrate 10.

The black matrices 15 according to an embodiment of the present invention are formed in the front substrate 10. Each of the black matrices 15 may include a first black matrix 15 formed at a location at which it is overlapped with a barrier rib 21, and second black matrices 11c and 12c formed between the transparent electrodes 11a and 12a and the bus electrodes 11b and 12b. The first black matrix 15, and the second black matrices 11c and 12c, which are also referred to as a “black layer” or a “black electrode layer”, may be formed at the same time and be connected physically, or may be formed separately and not be connected physically.

In the case where the first black matrix 15 and the second black matrices 11c and 12c are connected to each other physically, the first black matrix 15 and the second black matrices 11c and 12c may be formed using the same material. However, in the event that the first black matrix 15 and the second black matrices 11c and 12c are not connected to each other physically, the first black matrix 15 and the second black matrices 11c and 12c may be formed using different materials.

An upper dielectric layer 13 and a protection layer 14 are laminated on the front substrate 10 in which the scan electrodes 11 and the sustain electrodes 12 are formed in parallel. Charged particles generated by a discharge are accumulated on the upper dielectric layer 13. The upper dielectric layer 13 can serve to protect the sustain electrode pair 11 and 12. The protection layer 14 serves to protect the upper dielectric layer 13 from sputtering of charged particles generated during the discharge of a gas and also to increase emission efficiency of secondary electrons.

The address electrodes 22 are formed in such a way to cross the scan electrodes 11 and the sustain electrodes 12. Lower dielectric layers 24 and barrier ribs 21 are also formed on the rear substrate 20 in which the address electrodes 22 are formed.

A phosphor layer 23 is formed on the lower dielectric layers 24 and the surfaces of the barrier ribs 21. Each of the barrier ribs 21 includes a longitudinal barrier rib 21a and a traverse barrier rib 21b, which form a closed form. The barrier ribs 21 can separate discharge cells physically, and can also prevent ultraviolet rays generated by a discharge and a visible ray from leaking to neighboring discharge cells.

As shown in FIG. 1, it is preferred that a filter 100 be formed at the front of the PDP according to an embodiment of the present invention. The filter 100 may include an external light shielding sheet, an Anti-Reflection (AR) sheet, a Near Infrared (NIR) shielding sheet, an Electromagnetic Interference (EMI) shielding sheet, a diffusion sheet, an optical characteristic sheet, and so on.

When the distance between the filter 100 and the panel ranges from 10 to 30 μm, it can effectively block externally incident light and can also effectively emit light generated from the panel to the outside. To protect the panel from pressures from the outside, etc., the adhesive layer may have a thickness of 30 to 120 μm.

An adhesive layer for adhering the filter 100 and the panel may be formed between the filter 100 and the panel.

An embodiment of the present invention may be applied to not only the structure of the barrier ribs 21 shown in FIG. 1, but also the structure of barrier ribs having a variety of shapes. For example, an embodiment of the present invention may be applied to a differential type barrier rib structure in which the longitudinal barrier rib 21a and the traverse barrier rib 21b have different height, a channel type barrier rib structure in which a channel that can be used as an exhaust passage is formed in at least one of the longitudinal barrier rib 21a and the traverse barrier rib 21b, a hollow type barrier rib structure in which a hollow is formed in at least one of the longitudinal barrier rib 21a and the traverse barrier rib 21b.

In the differential type barrier rib structure, it is preferred that the traverse barrier rib 21b have a height “h” higher than that of the longitudinal barrier rib 21a. In the channel type barrier rib structure or the hollow type barrier rib structure, it is preferred that a channel or a hollow be formed in the traverse barrier rib 21b.

Meanwhile, in the present embodiment, it has been shown and described that the R, G, and B discharge cells are arranged on the same line. However, the R, G, and B discharge cells may be arranged in different forms. For example, the R, G, and B discharge cells may have a delta type arrangement in which they are arranged in a triangle. Furthermore, the discharge cells may be arranged in a variety of forms, such as square, pentagon and hexagon.

The phosphor layer is emitted with ultraviolet rays generated during the discharge of a gas to generate any one visible ray of red (R), green (G) and blue (B). Discharge spaces provided between the upper/rear substrates 10 and 20 and the barrier ribs 21 are injected with a mixed inert gas, such as He+Xe, Ne+Xe or He+Ne+Xe.

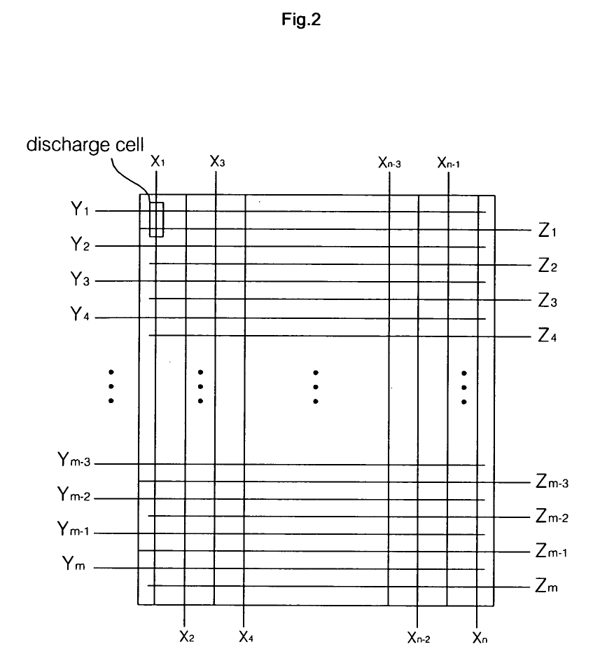

FIG. 2 is a view illustrating an embodiment of electrode arrangements of the PDP. It is preferred that a plurality of discharge cells constituting the PDP be arranged in matrix form, as illustrated in FIG. 2. The plurality of discharge cells are respectively disposed at the intersections of scan electrode lines Y1 to Ym, sustain electrodes lines Z1 to Zm, and address electrodes lines X1 to Xn. The scan electrode lines Y1 to Ym may be driven sequentially or simultaneously. The sustain electrode lines Z1 to Zm may be driven at the same time. The address electrode lines X1 to Xn may be driven with them being divided into even-numbered lines and odd-numbered lines, or may be driven sequentially.

The electrode arrangement shown in FIG. 2 is only an embodiment of the electrode arrangements of the PDP according to an embodiment of the present invention. Thus, the present invention is not limited to the electrode arrangements and the driving method of the PDP, as illustrated in FIG. 2. For example, the present invention may be applied to a dual scan method in which two of the scan electrode lines Y1 to Ym are driven at the same time. Furthermore, the address electrode lines X1 to Xn may be driven with them being divided into upper and lower parts on the basis of the center of the panel.

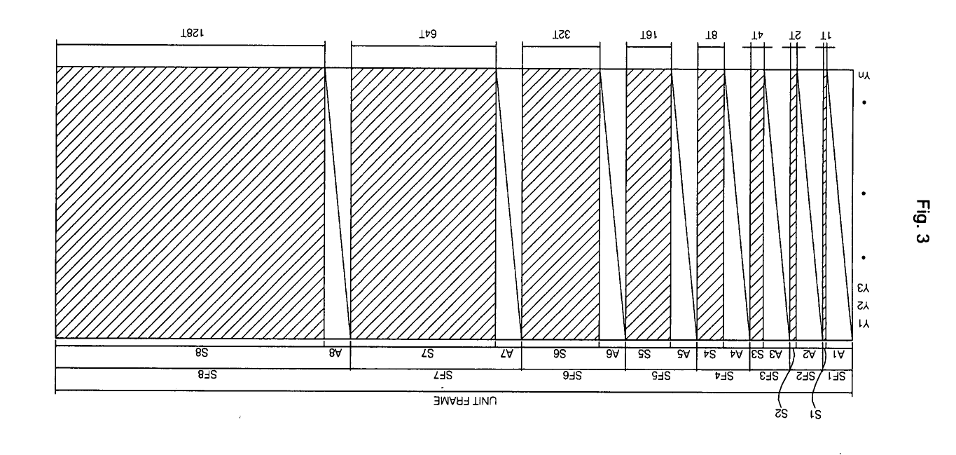

FIG. 3 is a timing diagram illustrating a method of driving a plasma display apparatus with one frame of an image being time-divided into a plurality of subfields. A unit frame may be divided into a specific number (for example, eight subfields SF1, . . . , SF8) in order to realize time-divided gray level display. Each of the subfields SF1, . . . , SF8 is divided into a reset period (not shown), address periods A1, . . . , A8, and sustain periods SI, . . . , S8. Alternatively, the unit frame may include twelve subfields. However, a case in which the unit frame includes eight subfields will be described as an example.

The reset period may be divided into a set-up period and a set-down period. In this case, according to an embodiment of the present invention, the set-up period of the reset period may be omitted from at least one of the plurality of subfields as movement increases in motion images. For example, the reset period may exist only in the first subfield, or may exist only in a subfield approximately between the first subfield and the whole subfields. This will be described in detail later on.

In each of the address periods A1, . . . , A8, an address signal is applied to address electrodes X, and scan signals corresponding to the respective scan electrodes Y are sequentially applied to the address electrodes X.

In each of the sustain periods S1, . . . , S8, a sustain signal is alternately applied to the scan electrodes Y and a sustain electrodes Z. Accordingly, a sustain discharge is generated in discharge cells on which wall charges are formed in the address periods A1, . . . , A8.

The luminance of the PDP is proportional to the number of sustain discharge pulses within the sustain periods S1, . . . , S8 occupied in the unit frame. In the case where one frame forming 1 image is represented by eight subfields and 256 gray levels, a different number of sustain signals may be sequentially allocated to the respective subfields in the ratio of 1, 2, 4, 8, 16, 32, 64, and 128. For example, to obtain the luminance of 133 gray levels, a sustain discharge can be generated by addressing cells during the subfield1 period, the subfield3 period, and the subfield8 period.

The number of sustain discharges allocated to each subfield may be varied depending on the weight of the subfield based on an Automatic Power Control (APC) step. That is, an example in which one frame is divided into eight subfields has been described with reference to FIG. 3. However, the present invention is not limited to the above example, but the number of subfields forming one frame may be varied depending on design specifications. For example, the PDP can be driven by dividing one frame into eight or more subfields, such as 12 or 16 subfields.

Furthermore, the number of sustain discharges allocated to each subfield may be changed in various ways by taking a gamma characteristic or a panel characteristic into consideration. For example, the degree of a gray level allocated to the subfield4 can be lowered from 8 to 6, and the degree of a gray level allocated to the subfield6 can be lowered from 32 to 34.

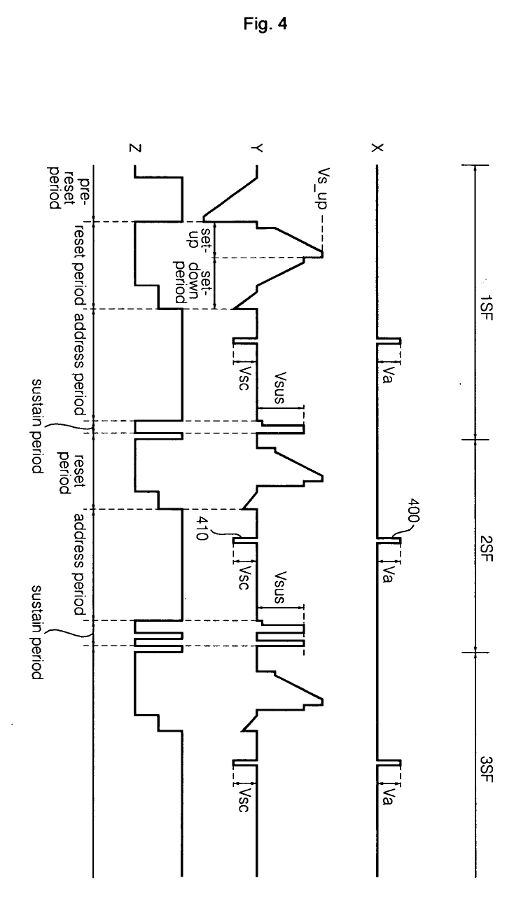

FIG. 4 is a timing diagram illustrating an embodiment of driving signals for driving a PDP in still images.

Each subfield includes a pre-reset period for forming positive wall charges on the scan electrodes Y and negative wall charges on the sustain electrodes Z, a reset period for initializing discharge cells of the whole screen by employing wall charge distributions formed by the pre-reset period, an address period for selecting discharge cells, and a sustain period for sustaining the discharge of selected discharge cells.

The reset period includes a setup period and a set-down period. In the setup period, a ramp-up waveform Ramp-up is applied to the entire scan electrodes at the same time. Thus, a minute discharge is generated in the entire discharge cells and wall charges are generated accordingly. In the set-down period, a ramp-down waveform Ramp-down, which falls from a positive voltage lower than a peak voltage of the ramp-up waveform, is applied to the entire scan electrodes Y at the same time. Accordingly, an erase discharge is generated in the entire discharge cells, thereby erasing unnecessary charges from the wall charges generated by the set-up discharge and spatial charges.

In the address period, a scan signal 410 having a negative scan voltage Vsc is sequentially applied to the scan electrodes Y, and an address signal 400 having a positive address voltage Va is applied to the address electrodes X so that the address signal 400 is overlapped with the scan signal. Therefore, an address discharge is generated due to a voltage difference between the scan signal 410 and the data signal 400 and a wall voltage generated during the reset period, so that cells are selected. Meanwhile, during the set-down period and the address period, a signal to sustain a sustain voltage is applied to the sustain electrodes Z.

In the sustain period, a sustain signal is alternately applied to the scan electrodes Y and the sustain electrodes Z. Accordingly, a sustain discharge occurs between the scan electrodes and the sustain electrodes in a surface discharge fashion.

The driving waveforms illustrated in FIG. 4 correspond to a first embodiment of signals for driving the PDP in still images, but the present invention is not limited to the waveforms illustrated in FIG. 4. For example, the pre-reset period may be omitted, the polarity and the degree of voltage change of the driving signals illustrated in FIG. 4 may be changed, if appropriate, and an erase signal for erasing wall charges may be applied to the sustain electrode after the sustain discharge is completed. Alternatively, a single sustain driving method is possible in which the sustain signal is applied to either the scan electrode Y and the sustain electrode Z, thus generating the sustain discharge.

The plasma display apparatus according to an embodiment of the present invention is constructed so that the amount of the set-up voltage Vs up decreases, a total number of set-up signals applied during the unit frame is reduced, or the number of sustain pulses is reduced, by changing the driving waveforms of still images as illustrated in FIG. 4 as the degree of a motion change of an image increases in motion images.

The plasma display apparatus according to an embodiment of the present invention includes first electrodes formed in a panel, and a first electrode driver configured to apply driving waveforms to the first electrodes. The first electrode driver applies different driving waveforms when motion images are output and when still images are output.

In the present invention, the motion images and the still images are classified as follows. In the case of the motion images, a gray level difference is generated in corresponding cells of a previous frame and a current frame, and in the case of the still images, the gray level difference does not occur.

In other words, when there is no change in the images of the previous frame and the current frame, the images are determined as the still images. When there is change in the gray level difference, the images are determined as the motion images.

The first electrode driver varies the driving waveform depending on the degree of movement of an object output from the screen (that is, the degree of change in images) when the motion images are output.

In the present invention, when motion images are displayed, a driving waveform different from that of still images is applied. Furthermore, the driving waveform is also changed depending on the image change degree.

The driving waveform is applied with it being changed according to the characteristic of the motion images. The degree of change in the motion images is first checked.

The degree of change in the image is determined by comparing two given frames. For example, a first frame and a second frame may be compared. The two frames are consecutive to each other. The first frame is anterior to the second frame. In the present embodiment, the first frame is referred to as a “previous frame”, and the second frame is referred to as a “current frame”.

The first electrode driver first compares corresponding cells of the previous frame and the current frame to determine the image change degree depending on how many cells, which do not have substantially the same gray level, are there. The degree of change of the image is decided according to the comparison result.

In the motion images, the gray level of a cell is continuously changed. When the whole screen is changed, it can be said that the image change degree is great, and when a portion of the whole screen is changed, the image change degree is small.

In other words, the image change degree of the current frame is determined depending on how many cells, which have a gray level difference in the current frame and the previous frame, are there. The gray level difference when a portion of the whole screen is changed is smaller that when the whole screen is changed, compared with the previous frame.

What the image change degree is divided into several steps according to a given reference as described above is called the image change degree.

It is meant that as the image change degree rises, cells having changed gray level are a lot, and as the image change degree lowers, cells having changed gray level are small.

In this case, in the case where corresponding cells of the two frames are compared with each other, a gray level difference value, becoming a reference for determining that there is a gray level change, is required. The reference value is called a “first reference value”.

If the gray level difference between the cell of the previous frame and the cell of the current frame is about 1 to 5, it is difficult to be seen by the eyes of human.

Accordingly, in the present invention, the first reference value may be set to a specific value ranging from about 15 to 20% of a total gray level number in order to set the range as a reference of gray level change.

If the gray level difference is smaller than the range, it is not seen by the eyes of human. Accordingly, whether gray levels of a cell have been changed is determined on the basis of a specific value within the range.

Accordingly, only when a gray level difference between two corresponding cells is higher than the first reference value, it is determined that there is change in the gray level of a corresponding cell. If the gray level difference is less than the first reference value, it is determined that there is no change in the gray level in a corresponding cell.

Cells having the gray level difference are summed. As the number of cells having the gray level change increases, the image change degree is high.

In this case, a case where gray levels of the entire cells are changed is set to the highest image change degree, and a case where gray levels of the entire cells are not changed is set to the lowest image change degree. An intermediate image change degree between the highest image change degree and the lowest image change degree is divided into specific steps, and the image change degree may be applied to the divided steps.

For example, the change degree of the whole gray levels may be divided into 16 steps, and the image change degree may be allocated according to the degree of movement of an image.

The change degree of the 16 steps may be divided depending on how many cells of the entire cells do the gray level difference higher than the first reference value have. In other words, the change degree can be determined by converting the gray level difference into the ratio of cells having the gray level difference higher than the first reference value, of the whole cells. It is not required to make constant the distance between the change degrees. If the gray level difference needs to be further divided, the cell ratio every change degree can be further divided.

TABLE 1

| CHANGE DEGREE OF IMAGE | RATIO (%) |
|---|---|
| 15 | 90 |
| 14 | 80 |
| 13 | 70 |
| 12 | 60 |
| 11 | 50 |
| 10 | 40 |
| 9 | 30 |
| 8 | 20 |
| 7 | 15 |
| 6 | 13 |
| 5 | 11 |
| 4 | 9 |
| 3 | 7 |
| 2 | 5 |
| 1 | 3 |
| 0 | 1 |

Table 1 illustrates the ratio of cells having a gray level difference on a change-degree basis according to an embodiment of the present invention. The ratio can be properly controlled, if appropriate.

In this case, it can be considered that as the image change degree increases, the degree of movement of the current frame is greater than that of the previous frame.

If the degree of movement of the current frame is matched to any one of the subdivided change degrees of the image as described above, the first electrode driver applies a driving waveform corresponding to the image change degree to the first electrode.

In the first embodiment of the plasma display apparatus according to the present invention, the number of set-up signals of a driving waveform applied to the scan electrode may be set smaller than that of still images. In this case, the first electrode is the scan electrode.

The set-up signals are generally allocated one by one on a subfield basis in still images, as illustrated in FIG. 4. In the case of motion images, the number of set-up signals is reduced so that the set-up signals are not applied in a specific subfield.

As the change degree of the motion images increases, the number of set-up signals applied during the unit frame is further reduced in order to save power.

A method of reducing the number of set-up signals can be applied as follows. In other words, a set-up signal period is removed from a driving waveform, and the removed period may be used to supplement other signals. That is, driving margin as much as the set-up signal period is applied in the sustain period in order to use it as other purposes, such as dividing gray level. In a panel screen of a large size, it is frequent that the address period is short. In this case, driving margin as much as the set-up signal period can be allocated to the address period.

The set-up signal serves to adjust wall charges of a discharge cell for the purpose of a next discharge. In the case where a screen having lots of movements is output, such as motion images, the picture quality is not significantly degraded although the set-up signal is removed from a specific subfield.

In a second embodiment of the present invention, the voltage of the set-up signal is set lower than that of still images in a specific subfield, thus saving power.

The set-up signal is applied, but is applied with the amount of the set-up signal being decreased compared with still images. In this case, power can be saved while significantly degrading the picture quality.

The first electrode driver can make the set-up voltage gradually low as the image change degree increases. That is, as the movement of motion images increases, the amount of a set-up voltage used in subfields constituting one frame is further lowered, thus saving power consumption.

In the case of the first and second embodiments, reference will be made to Table to be described later.

A third embodiment of the present invention may be adapted to decrease the number of sustain pulses applied during the sustain. In other words, in the case of motion images, the number of the whole gray level degrees can be reduced by changing subfield mapping as the degree of movement of an image increases. In this case, the first electrode becomes the scan electrode or the sustain electrode.

For example, in the case of still images, the change degree of 256 gray levels is used. In the case of motion images, however, the number of sustain pulses may be allocated by allocating the change degree of the whole gray levels, such as 180 gray levels or 128 gray levels, depending on the degree of movement.

In a fourth embodiment of the present invention, the above three embodiments may be properly combined and used. As the image change degree increases, a set-up signal may be removed from several subfields, and the amount of a set-up voltage or the number of sustain pulses may be decreased in other subfields. It is therefore possible to efficiently save power consumption.

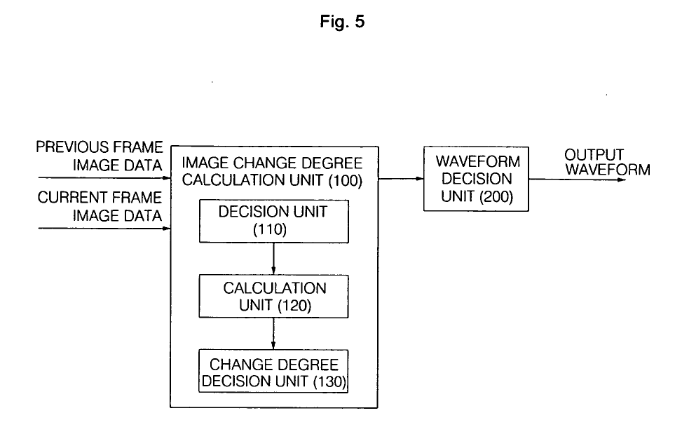

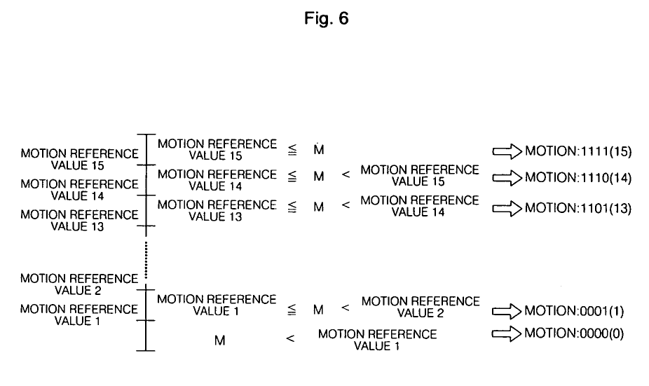

FIG. 5 is a block diagram showing the construction of a plasma display apparatus according to an embodiment of the present invention. FIG. 6 is a view illustrating a method of determining the degree of a motion change of the plasma display apparatus according to an embodiment of the present invention.

The plasma display apparatus according to an embodiment of the present invention includes an image change degree calculation unit 100 configured to calculate the image change degree depending on the number of cells whose gray level difference between the previous frame and the current frame is higher than a given value, and a waveform decision unit 200 configured to change a driving waveform applied during the unit frame according to the calculated change degree of an image.

The image change degree calculation unit 100 analyzes an image, measures the degree of movement when the image is a motion image, and divides the change degree into several steps.

In order to measure the degree of movement of the motion image, the image change degree calculation unit 100 compares corresponding cells of the previous frame and the current frame to determine in how many cells has movement occurred, and decides the image change degree based on the number of cells in which the movement has occurred.

For the above operation, the image change degree calculation unit 100 includes a decision unit 110 configured to determine how much has the gray levels of corresponding cells been changed in the previous frame and the current frame (that is, compares the gray level difference in a corresponding cell of the previous frame and the current frame with the first reference value) in order to determine whether there is movement of the image, a calculation unit 120 configured to sum the number of cells having motion change, which are determined in the decision unit, and a change degree decision unit 130 configured to decide the degree of motion change of a corresponding frame according to the summed number of cells.

The decision unit 110 compares cells of the previous frame and the current frame, and determines that the cells have a motion change in motion images when the gray level difference is higher than the first reference value.

Accordingly, the decision unit 110 sets a gray level difference, which becomes a reference, and detects only cells exhibiting the gray level difference higher than the first reference value. Thus, the decision unit 110 can determine an image is a still image or not on a cell basis.

Basically, the first reference value may have a constant value between the lowest gray level, and the highest gray level value that can be represented by a PDP.

However, in the case of a very small gray level difference, there is a case where the very small gray level difference is determined to be a cell visually not having movement. Thus, if the reference value is too low, a problem arises because cells corresponding to such small movement are determined to be cells having lots of movement.

Furthermore, in the case where the first reference value is too high, corresponding cells are detected only when movement is very great. Accordingly, a problem may occur in which cells of motion images are also determined to be cells of still images.

Accordingly, in an embodiment of determining the first reference value, in order to find the first reference value, a screen from a very small movement to an abrupt movement is output, a first frame and a frame of a point of time at which it is considered to be a motion image are compared with each other, and the gray level difference between cells of both frames is averaged on the whole.

In the plasma display apparatus according to the present invention, in the case of an image having the whole gray level of 256, the first reference value is set to a value between approximately 40 to 50 gray levels. That is, when the gray level difference between the cells of the previous frame and the current frame is less than a specific value between approximately 15 to 20% gray levels of the whole gray level number, these cells are not considered since the movement of a motion is very weak.

The calculation unit 120 sums the number of cells, which have been determined to have the gray level difference higher than the first reference value in the decision unit 110 (that is, the number of cells corresponding to an image having movement). In other words, the count of the calculation unit 120 is increased one by one according to the determination signal of the decision unit 110.

The decision unit 110 and the calculation unit 120 repeatedly perform the same process until all cells of the previous frame and the current frame are compared.

If the above process is completed on all the cells in the calculation unit 120, the sum M of cells having the gray level difference higher than the first reference value is finally summed, and the summed value is transmitted to the change degree decision unit 130.

The change degree decision unit 130 decides the change degree by matching any one of the change degrees of an image having two or more steps based on the summed number M of the cells.

It has been described above that the whole change degrees of an image is divided into sixteen change degrees. However, the present invention is not limited thereto, but the whole change degrees of an image may be divided properly.

In this case, referring to Table 1, the 16 levels may be decided by converting them into the ratio of cells having the gray level difference higher than the first reference value, of the whole cells.

The image change degree may be classified by allocating a specific bit on a step basis.

The bit number of a signal required to represent the change degree of the sixteen steps is 4 bits. The change degree having the smallest movement is a 0 change degree, and the change degree having the greatest movement is a 15 change degree.

Furthermore, a motion reference value is set every image change degree. The motion reference value is a value in which the number of cells whose gray level difference between the previous frame and the current frame is higher than the first reference value is assigned according to the change degree.

Referring to FIG. 6, when the summed number M of cells is smaller than the reference value 1, it is determined that there is no movement, and therefore the image change degree is set to 0. Accordingly, motion bits indicating a case where the image change degree is 0 becomes 0000.

When the M is the same as or greater than the motion reference value 13, and is lower than the motion reference value 14, the image change degree is set to a 13 change degree, and motion bits indicating the 13 change degree becomes 1101.

The image change degree calculation unit 100 outputs the motion bits to the waveform decision unit 200 as output signals.

The waveform decision unit 20 varies the driving waveform based on the motion bits.

In other words, the waveform decision unit 200 varies the number of subfields, the number of sustain pulses or the number of reset signals based on the image change degree.

As the image change degree increases, gray level representation steps can be decreased by properly reducing the number of subfields, thus increasing the margin of a driving signal, or the margin of a driving signal can be increased by decreasing the number of sustain pulses.

In the plasma display apparatus according to the present invention, in an embodiment, the waveform decision unit 200 varies one or more of the number of set-up signals and the number of set-up voltages applied during the unit frame according to the calculated image change degree.

In other words, the plasma display apparatus of the present invention includes a table of driving waveforms corresponding to the motion bits in order to output a control signal for outputting waveforms corresponding to input motion bits.

In a detailed embodiment of the plasma display apparatus according to the present invention, the waveform decision unit 200 is adapted to decrease the number of set-up signals applied during the unit frame as the image change degree increases. As the image change degree increases, the number of signals applied to the electrodes of the panel is increased, and a great amount of heat is generated in the electrode driver IC due to the amount of change in the signal. The reduction of the set-up signal leads to a decrease in the amount of heat generated.

Furthermore, the distortion of an image, which may occur by reducing the number of set-up signals, is not greatly seen visually since the degree of change in the screen is great, thus not posing a feeling of visual rejection. Accordingly, images can be displayed effectively, and the margin of a driving signal can be extended.

In another embodiment of the plasma display apparatus according to the present invention, the waveform decision unit 200 is adapted to decrease the set-up voltage as the image change degree increases.

This will be described in detail below with reference to Table 2.

TABLE 2

| | NUMBER OF | SET-UP |
|---|---|---|
| MOTION BIT | SET-UP SIGNAL | VOLTAGE (V) |
| 1111(15) | 1 | 180 |
| 1110(14) | 1 | 185 |
| 1101(13) | 2 | 190 |
| 1100(12) | 2 | 195 |
| 1011(11) | 2 | 200 |
| 1010(10) | 3 | 205 |
| 1001(9) | 3 | 210 |
| 1000(8) | 3 | 215 |
| 0111(7) | 4 | 220 |
| 0110(6) | 4 | 225 |
| 0101(5) | 4 | 230 |
| 0100(4) | 5 | 230 |
| 0011(3) | 5 | 235 |
| 0010(2) | 6 | 235 |
| 0001(1) | 6 | 240 |
| 0000(0) | 6 | 240 |

Table 2 is a table illustrating an embodiment of the number of set-up signals applied according to the image change degree the plasma display apparatus according to the present invention, and a voltage table.

In other words, as described above, the plasma display apparatus according to the present invention is constructed to reduce the number of the set-up signals or decrease the amount of the set-up voltage as the image change degree becomes high.

When the image change degree is 0, it can be considered as still images. In this case, the plasma display apparatus can be constructed to have the largest set-up number and the highest voltage.

As the image change degree becomes high, the number of set-up signals may be decreased while lowering the set-up voltage, or they can be performed independently.

Accordingly, the waveform decision unit 200 includes a table in which the number of set-up signals and the amount of voltage are set according to the image change degree as described above. The table is mapped according to input motion bits, waveforms are determined so that waveforms having the number of corresponding set-up signals and the amount of voltage can be output, and a signal is output to each electrode driver.

In the plasma display apparatus according to still another embodiment of the present invention, the waveform decision unit 200 may be constructed to decrease the number of sustain pulses applied during the unit frame as the image change degree increases.

In other words, in order to decrease the number of sustain pulses, the number of gray levels representing a corresponding frame is reduced. That is, when a common still image is represented with 256 gray levels, a motion image is represented with 180 gray levels or 128 gray levels. In the motion image, the number of gray levels is reduced as the degree of movement increases. A screen having lots of motions looks like that it passes fast visually. Thus, a small reduction in the number of gray levels does not pose a significant problem visually. That is, the image is represented with 180 gray levels in a screen having a little motion, and the image is represented with 128 or 100 gray levels in a screen having lots of motions.

If the number of gray levels is decreased as described above, the number of sustain pulses for representing corresponding gray levels is also decreased. That is, the subfield-mapping table used in the case of motion images and the subfield-mapping table used in the case of still images are constructed differently.

The image change degree calculation unit 100 and the waveform decision unit 200 constructed above may be included in a control board, an electrode driving board or a signal processor of a PDP.

In the case of motion images, the margin of a driving signal and an optical characteristic can be improved using a waveform decided as described above. Accordingly, an image frame can be represented efficiently.

The plasma display apparatus constructed as described above can save power consumption of a panel, so that a plasma display apparatus with low power consumption can be provided. Furthermore, as a driving waveform is driven variably, the distortion of an image, which occurs as a waveform is varied, can be minimized. Furthermore, there are advantages in that the margin of a driving signal can be enhanced, heat generated from a panel can be reduced, and damage to the panel can be prevented. In particular, there is an advantage in that a contrast characteristic of an image can be improved since a gray level difference can differ according to motion.

While the plasma display apparatus according to an embodiment of the present invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display apparatus, comprising:
a first electrode formed in a panel; and
a first electrode driver configured to apply a driving waveform to the first electrode,
wherein the first electrode driver applies different driving waveforms when motion images are output and when still images are output.

2. The plasma display apparatus of claim 1, wherein the first electrode driver applies a different driving waveform according to a image change degree when the motion images are output.

3. The plasma display apparatus of claim 2, wherein the image change degree is decided by comparing a gray level difference of corresponding cells of a previous frame and a current frame.

4. The plasma display apparatus of claim 3, wherein the image change degree becomes high as the number of cells whose gray level difference is higher than a first reference value increases.

5. The plasma display apparatus of claim 4, wherein the first reference value is a constant value between 15 to 20% of a total number of gray levels.

6. The plasma display apparatus of claim 4, wherein the first electrode driver varies the driving waveform by dividing the image change degree into specific steps.

7. The plasma display apparatus of claim 4, wherein the first electrode driver varies the number of set-up signals in a decreasing manner as the image change degree becomes high.

8. The plasma display apparatus of claim 4, wherein the first electrode driver varies an amount of set-up voltage in a decreasing manner as the image change degree becomes high.

9. The plasma display apparatus of claim 5, wherein the first electrode driver varies the number of sustain pulses applied in a sustain period according to the image change degree.

10. The plasma display apparatus of claim 9, wherein the number of sustain pulses is decreased as the image change degree becomes high.

11. A plasma display apparatus, comprising:
a first electrode formed in a panel; and
a first electrode driver configured to apply a driving waveform to the first electrode,
wherein the first electrode driver sets a driving waveform applied to a first frame and a driving waveform applied to a second frame to differ from each other when a gray level difference of cells of the first frame and the second frame is greater than a first reference value.

12. The plasma display apparatus of claim 11, wherein the first frame and the second frame are two consecutive frames.

13. The plasma display apparatus of claim 12, wherein the first reference value is a constant value between 15 to 20% of a total number of gray levels.

14. The plasma display apparatus of claim 13, wherein the first electrode driver sets the number of set-up signals of the driving waveform applied in the second frame to be smaller than the number of set-up signals of the driving waveform applied in the first frame.

15. The plasma display apparatus of claim 14, wherein as the number of cells whose gray level difference is higher than the first reference value increases, the number of set-up signals applied in the first frame is smaller than the number of set-up signals applied in the second frame.

16. The plasma display apparatus of claim 13, wherein the first electrode driver sets the amount of set-up voltage of the driving waveform applied in the second frame to be smaller than the amount of set-up voltage of the driving waveform applied in the first frame.

17. The plasma display apparatus of claim 16, wherein as the number of cells whose gray level difference is higher than the first reference value increases, the number of set-up voltage applied in the first frame is smaller than the number of set-up voltage applied in the second frame.

18. The plasma display apparatus of claim 13, wherein the first electrode driver sets the number of sustain pulses of the driving waveform applied in the second frame to be smaller than the number of sustain pulses of the driving waveform applied in the first frame.

19. The plasma display apparatus of claim 18, wherein as the number of cells whose gray level difference is higher than the first reference value increases, the number of sustain pulses applied in the first frame is smaller than the number of sustain pulses applied in the second frame.
